(19) United States
(12) Patent Application Publication
(10) Pub. No.: US 2023/0010286 A1
(43) Pub. Date: Jan. 12, 2023

(54) Wireless Speaker And Camera Assembly

(71) Applicant: Frank Solchaga, Azusa, CA (US)

(72) Inventor: Frank Solchaga, Azusa, CA (US)

(21) Appl. No.: 17/370,342

(22) Filed: Jul. 8, 2021

(51) Int. Cl. H04N 5/225; H04R 1/02; H04N 5/232; H04N 5/765; G06F 3/16

(52) U.S. Cl. CPC H04N 5/2257; H04R 1/021; H04N 5/23203; H04N 5/765; H04N 5/23216; G06F 3/165; H04R 2420/07; H02J 7/0045

(57) ABSTRACT

A wireless speaker and camera assembly includes a remote control for storing data comprising a remote control program. A housing is included and a speaker is integrated into the housing to emit audible sound outwardly therefrom. A camera is integrated into the housing to capture images of the environment in which the housing is positioned. A transceiver is integrated into the housing and the transceiver is in communication with the speaker and the camera. Additionally, the transceiver is in remote communication with the remote control to send and receive audio data and image data with respect to the remote control thereby facilitating the speaker to stream audio received from the remote control.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to wireless devices and more particularly pertains to a new wireless device for remotely capturing digital imagery and streaming audio. The device includes a housing that has a speaker and a camera integrated into the housing. A transceiver is integrated into the housing for communicating with a personal electronic device. In this way the speaker can stream audio from the personal electronic device and the camera can broadcast imagery to the personal electronic device.

### (2) Description of Related Art including information disclosed under 37 CFR 1.97 and 1.98.

The prior art relates to wireless devices including a wireless speaker and digital camera that includes a rectangular housing. The prior art discloses a variety of wireless speaker devices that can receive an audio signal from a personal electronic device. The prior art discloses a wireless camera device that includes a pair of displays and a video camera that is in communication with a personal electronic device. In no instance does the prior art disclose a wireless speaker and digital camera that includes a tubular housing.

### BRIEF SUMMARY OF THE INVENTION

An embodiment of the disclosure meets the needs presented above by generally comprising a remote control for storing data comprising a remote control program. A housing is included and a speaker is integrated into the housing to emit audible sound outwardly therefrom. A camera is integrated into the housing to capture images of the environment in which the housing is positioned. A transceiver is integrated into the housing and the transceiver is in communication with the speaker and the camera. Additionally, the transceiver is in remote communication with the remote control to send and receive audio data and image data with respect to the remote control thereby facilitating the speaker to stream audio received from the remote control.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a wireless speaker and camera assembly according to an embodiment of the disclosure.

FIG. 2 is a right side view of an embodiment of the disclosure.

FIG. 3 is a front view of an embodiment of the disclosure.

FIG. 4 is a bottom phantom view of an embodiment of the disclosure.

FIG. 5 is a schematic view of an embodiment of the disclosure.

### DETAILED DESCRIPTION OF THE INVENTION

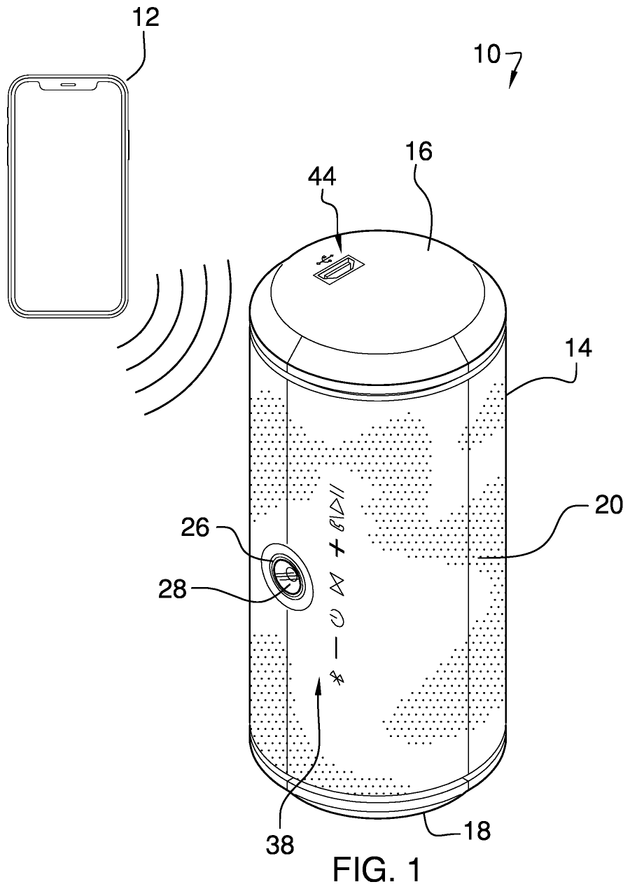

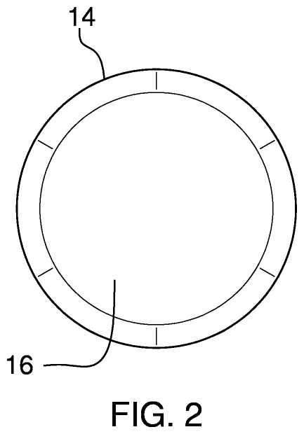

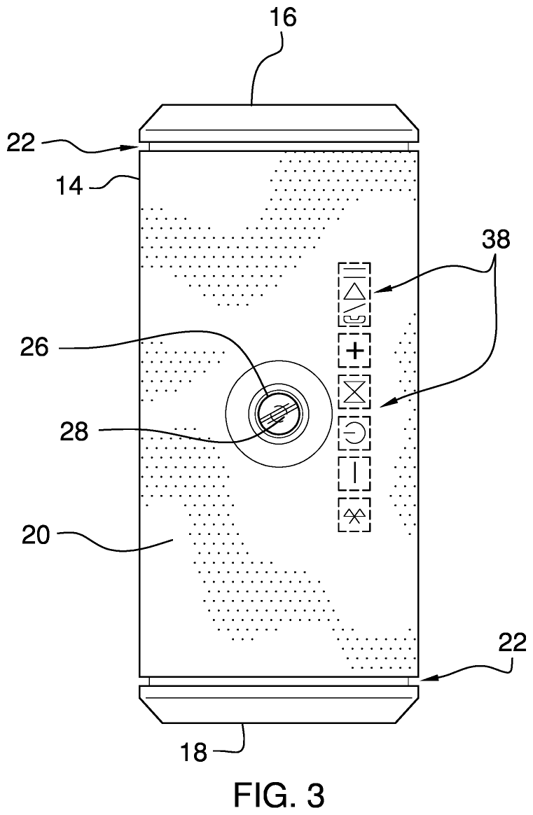

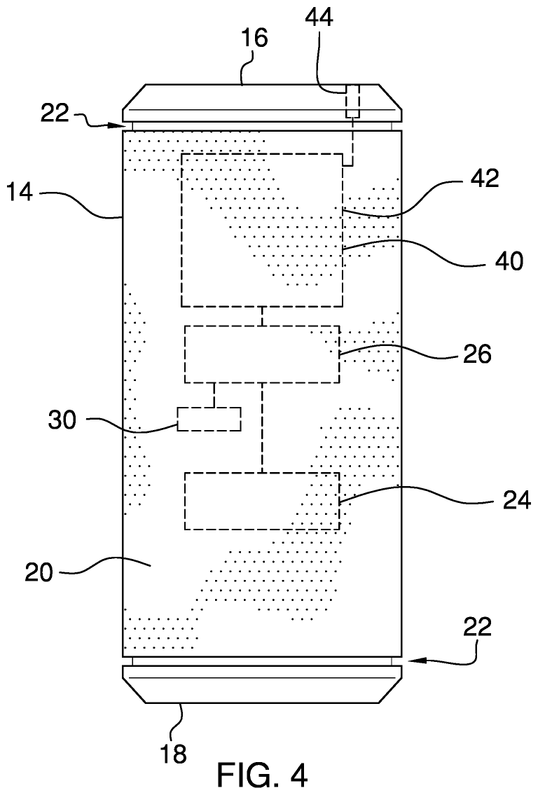

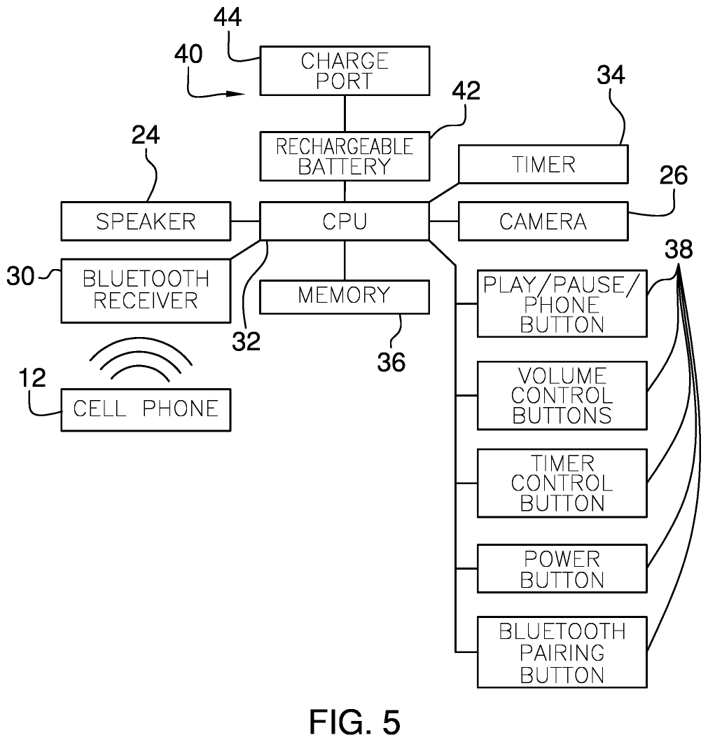

With reference now to the drawings, and in particular to FIGS. 1 through 5 thereof, a new wireless device embodying the principles and concepts of an embodiment of the disclosure and generally designated by the reference numeral 10 will be described.

As best illustrated in FIGS. 1 through 5, the wireless speaker and camera assembly 10 generally comprises a personal electronic device 12 that stores data comprising a remote control program. Additionally, the personal electronic device 12 has wireless communication capabilities. The personal electronic device 12 might comprise a smart phone or other similar device that has Bluetooth communication capabilities and which includes video and audio capabilities. Furthermore, the remote control program might comprise a smart phone app that is stored in the smart phone.

A housing 14 has a tubular shape to facilitate sound waves to propagate through the housing 14. The housing 14 has a first end 16, a second end 18 and an outer wall 20 extending between the first end 16 and the second end 18, and the housing 14 is substantially hollow. The outer wall 20 is continuously arcuate about an axis extending through the first end 16 and the second end 18, and the outer wall 20 has a pair of grooves 22 each extending inwardly on the outer wall 20. Each of the grooves 22 extends around a full circumference of the outer wall 20 and each of the grooves 22 is positioned adjacent to a respective one of the first end 16 and the second end 18. Additionally, the outer wall 20 is chamfered at an intersection between each of the first end 16 and the second end 18.

A speaker 24 is integrated into the housing 14 to emit audible sound outwardly therefrom and a camera 26 is integrated into the housing 14 to capture images of the environment in which the housing 14 is positioned. The camera 26 is integrated into the outer wall 20 of the housing 14 and the camera 26 includes a lens 28 that is exposed with respect to the outer wall 20. The speaker 24 may comprise an electronic speaker of any conventional design and the camera 26 may comprise a digital camera of any conventional design that can record video and capture still images.

A transceiver 30 is integrated into the housing 14 and the transceiver 30 is in communication with the speaker 24 and the camera 26. The transceiver 30 is in remote communication with the personal electronic device 12 to send and receive audio data and image data with respect to the personal electronic device 12. In this way the speaker 24 can stream audio received from the personal electronic device 12. Additionally, the transceiver 30 receives a control signal from the personal electronic device 12 comprising operational commands for controlling operational parameters of the speaker 24 and the camera 26. The transceiver 30 may comprise a radio frequency transceiver or the like and the transceiver 30 may employ Bluetooth communication protocols.

A control circuit 32 is integrated into the housing 14 and the control circuit 32 is electrically coupled to each of the camera 26, the speaker 24 and the transceiver 30. The control circuit 32 receives the control signal from the transceiver 30 and the control circuit 32 controls each of the speaker 24 and the camera 26 according to the operational commands in the control signal. An electronic timer 34 is integrated into the housing 14 and the electronic timer 34 is electrically coupled to the control circuit 32. The electronic timer 34 is in communication with the camera 26 to facilitate the camera 26 to take time delayed images.

An electronic memory 36 is integrated into the housing 14 and the electronic memory 36 is electrically coupled to the control circuit 32. The electronic memory 36 stores data comprising images captured by the camera 26. Additionally, the data in the electronic memory 36 is downloadable into the personal electronic device 12 to facilitate the images to be viewed. The electronic memory 36 may comprise solid state memory such as random access memory or the like. A plurality of control buttons 38 is each movably integrated into the outer wall 20 of the housing 14 and each of the control buttons 38 is electrically coupled to the control circuit 32. Each of the control buttons 38 controls respective operational parameters of the speaker 24, the camera 26 and the transceiver 30. The operational parameters may include, but not be limited to, volume increase, volume decrease, play/pause, power on and off, pairing and timer duration.

A power supply 40 is integrated into the housing 14 and the power supply 40 is electrically coupled to the control circuit 32. The power supply 40 comprises at least one battery 42 that is positioned in the housing 14 and the at least one battery 42 is electrically coupled to the control circuit 32. The power supply 40 includes a charge port 44 that is recessed into the housing 14 to receive a charge cord. The charge port 44 is electrically coupled to the at least one battery 42 for charging the at least one battery 42. Additionally, the charge port 44 may comprise a micro universal serial bus port or other similar type of charge port.

In use, the housing 14 is positioned in a location that a user wishes to capture video footage or still images while also listening to music, for example. The location might be a golf course on which the user is playing golf, a family gathering or any other occasion the user might deem appropriate. The transceiver 30 is synched with the personal electronic device 12 to facilitate the speaker 24 to stream audio from the personal electronic device 12. Additionally, the camera 26 and the speaker 24 can be controlled with the personal electronic device 12, and imager stored in the electronic memory 36 can be downloaded into the personal electronic device 12 for subsequent viewing or editing.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A wireless speaker and camera assembly being wirelessly connected to a personal electronic device for streaming music and capturing images, said assembly comprising:
a remote control storing data comprising a remote control program, said remote control having wireless communication capabilities;
a housing having a tubular shape wherein said housing is configured to facilitate sound waves to propagate through said housing;
a speaker being integrated into said housing wherein said speaker is configured to emit audible sound outwardly therefrom;
a camera being integrated into said housing wherein said camera is configured to capture images of the environment in which said housing is positioned; and
a transceiver being integrated into said housing, said transceiver being in communication with said speaker and said camera, said transceiver being in remote communication with said remote control to send and receive audio data and image data with respect to said remote control thereby facilitating said speaker to stream audio received from said remote control, said transceiver receiving a control signal from said remote control comprising operational commands for controlling operational parameters of said speaker and said camera.

2. The assembly according to claim 1, wherein:
said housing has a first end, a second end and an outer wall extending between said first end and said second end, said housing being substantially hollow, said outer wall being continuously arcuate about an axis extending through said first end and said second end, said outer wall having a pair of grooves each extending inwardly on said outer wall, each of said grooves extending around a full circumference of said outer wall, each of said grooves being positioned adjacent to a respective one of said first end and said second end, said outer wall being chamfered at an intersection between each of said first end and said second end; and
said camera is integrated into said outer wall of said housing, said camera including a lens being exposed with respect to said outer wall.

3. The assembly according to claim 1, further comprising:
a control circuit being integrated into said housing, said control circuit being electrically coupled to each of said camera, said speaker and said transceiver, said control circuit receiving said control signal from said transceiver, said control circuit controlling each of said speaker and said camera according to operational commands in said control signal;
an electronic timer being integrated into said housing, said electronic timer being electrically coupled to said control circuit, said electronic timer being in communication with said camera to facilitate said camera to take time delayed images; and
an electronic memory being integrated into said housing, said electronic memory being electrically coupled to said control circuit, said electronic memory storing data comprising images captured by said camera, said data in said electronic memory being downloadable into said remote control wherein said remote control is configured to facilitate the images to be viewed.

4. The assembly according to claim 3, further comprising a plurality of control buttons, each of said control buttons being movably integrated into an outer wall of said housing, each of said control buttons being electrically coupled to said control circuit, each of said control buttons controlling respective operational parameters of said speaker, said camera and said transceiver, said operational parameters including volume increase, volume decrease, play/pause, power on and off, pairing, and timer duration.

5. A wireless speaker and camera assembly being wirelessly connected to a personal electronic device for streaming music and capturing images, said assembly comprising:
a remote control storing data comprising a remote control program, said remote control having wireless communication capabilities;
a housing having a tubular shape wherein said housing is configured to facilitate sound waves to propagate through said housing, said housing having a first end, a second end, and an outer wall extending between said first end and said second end, said housing being substantially hollow, said outer wall being continuously arcuate about an axis extending through said first end and said second end, said outer wall having a pair of grooves each extending inwardly on said outer wall, each of said grooves extending around a full circumference of said outer wall, each of said grooves being positioned adjacent to a respective one of said first end and said second end, said outer wall being chamfered at an intersection between each of said first end and said second end;
a speaker being integrated into said housing wherein said speaker is configured to emit audible sound outwardly therefrom;
a camera being integrated into said housing wherein said camera is configured to capture images of the environment in which said housing is positioned, said camera being integrated into said outer wall of said housing, said camera including a lens being exposed with respect to said outer wall;
a transceiver being integrated into said housing, said transceiver being in communication with said speaker and said camera, said transceiver being in remote communication with said remote control to send and receive audio data and image data with respect to said remote control thereby facilitating said speaker to stream audio received from said remote control, said transceiver receiving a control signal from said remote control comprising operational commands for controlling operational parameters of said speaker and said camera;
a control circuit being integrated into said housing, said control circuit being electrically coupled to each of said camera, said speaker and said transceiver, said control circuit receiving said control signal from said transceiver, said control circuit controlling each of said speaker and said camera according to operational commands in said control signal;
an electronic timer being integrated into said housing, said electronic timer being electrically coupled to said control circuit, said electronic timer being in communication with said camera to facilitate said camera to take time delayed images;
an electronic memory being integrated into said housing, said electronic memory being electrically coupled to said control circuit, said electronic memory storing data comprising images captured by said camera, said data in said electronic memory being downloadable into said remote control wherein said remote control is configured to facilitate the images to be viewed;
a plurality of control buttons, each of said control buttons being movably integrated into said outer wall of said housing, each of said control buttons being electrically coupled to said control circuit, each of said control buttons controlling respective operational parameters of said speaker, said camera and said transceiver, said operational parameters including volume increase, volume decrease, play/pause, power on and off, pairing, and timer duration; and
a power supply being integrated into said housing, said power supply being electrically coupled to said control circuit, said power supply comprising:
at least one battery being positioned in said housing, said at least one battery being electrically coupled to said control circuit; and
a charge port being recessed into said housing wherein said charge port is configured to receive a charge cord, said charge port being electrically coupled to said at least one battery for charging said at least one battery.

6. A wireless speaker camera system being wirelessly connected to a personal electronic device for streaming music and capturing images, said assembly comprising:
a personal electronic device storing data comprising a control program, said personal electronic device having wireless communication capabilities;
a housing having a tubular shape wherein said housing is configured to facilitate sound waves to propagate through said housing, said housing having a first end, a second end, and an outer wall extending between said first end and said second end, said housing being substantially hollow, said outer wall being continuously arcuate about an axis extending through said first end and said second end, said outer wall having a pair of grooves each extending inwardly on said outer wall, each of said grooves extending around a full circumference of said outer wall, each of said grooves being positioned adjacent to a respective one of said first end and said second end, said outer wall being chamfered at an intersection between each of said first end and said second end;
a speaker being integrated into said housing wherein said speaker is configured to emit audible sound outwardly therefrom;
a camera being integrated into said housing wherein said camera is configured to capture images of the environment in which said housing is positioned, said camera being integrated into said outer wall of said housing, said camera including a lens being exposed with respect to said outer wall;
a transceiver being integrated into said housing, said transceiver being in communication with said speaker and said camera, said transceiver being in remote communication with said personal electronic device to send and receive audio data and image data with respect to said personal electronic device thereby facilitating said speaker to stream audio received from said personal electronic device, said transceiver receiving a control signal from said personal electronic device comprising operational commands for controlling operational parameters of said speaker and said camera;
a control circuit being integrated into said housing, said control circuit being electrically coupled to each of said camera, said speaker and said transceiver, said control circuit receiving said control signal from said transceiver, said control circuit controlling each of said speaker and said camera according to operational commands in said control signal;
an electronic timer being integrated into said housing, said electronic timer being electrically coupled to said control circuit, said electronic timer being in communication with said camera to facilitate said camera to take time delayed images;
an electronic memory being integrated into said housing, said electronic memory being electrically coupled to said control circuit, said electronic memory storing data comprising images captured by said camera, said data in said electronic memory being downloadable into said personal electronic device wherein said personal electronic device is configured to facilitate the images to be viewed;
a plurality of control buttons, each of said control buttons being movably integrated into said outer wall of said housing, each of said control buttons being electrically coupled to said control circuit, each of said control buttons controlling respective operational parameters of said speaker, said camera and said transceiver, said operational parameters including volume increase, volume decrease, play/pause, power on and off, pairing, and timer duration; and
a power supply being integrated into said housing, said power supply being electrically coupled to said control circuit, said power supply comprising:
at least one battery being positioned in said housing, said at least one battery being electrically coupled to said control circuit; and
a charge port being recessed into said housing wherein said charge port is configured to receive a charge cord, said charge port being electrically coupled to said at least one battery for charging said at least one battery.
